(19) United States
(12) Patent Application Publication
(10) Pub. No.: US 2006/0263732 A1
(43) Pub. Date: Nov. 23, 2006

(54) Candle, fuel element for a tea light or a granulate for the candle or the fuel element and a method and apparatus for making the candle, fuel element or granulate

(76) Inventor: Wolfgang Fiwek, Wohltorf (DE)

Correspondence Address: WALTER OTTESEN, PO BOX 4026, GAITHERSBURG, MD, 20885-4026, US

(21) Appl. No.: 11/436,085

(22) Filed: May 18, 2006

(30) Foreign Application Priority Data
May 18, 2005 (DE) 10 2005 022 700.7

(51) Int. Cl. B29C 47/00; F23D 3/16

(52) U.S. Cl. 431/291; 425/308; 264/211.11; 264/148; 264/319; 425/296

(57) ABSTRACT

A fuel element or a granulate having increased quality is provided whose fuel mass can be compacted. A method and apparatus for making the fuel element or the granulate is provided which reduces the complexity of apparatus. The fuel element or the granulate is compacted and the portion of the renewable raw materials amounts to more than 30%. The mixing, the compression and the compaction of the fuel mass takes place in a closed chamber and in a continuous process during which the liquid and heated fuel mass is continuously cooled and the extrusion is cut into predetermined lengths. The apparatus is configured as an extrusion machine wherein all required units are brought together for mixing the liquid heated fuel mass with possible additives and additional substances and for compressing and compacting the same and for thermally treating the fuel mass. The equipment for the thermal treatment of the fuel mass is configured as a cooling system which extends from the mixing unit to the compressing unit and compacting unit.

### CROSS REFERENCE TO RELATED APPLICATION

This application claims priority of German patent application no. 10 2005 022 700.7, filed May 18, 2005, the entire content of which is incorporated herein by reference.

### BACKGROUND OF THE INVENTION

As a rule, a tea light comprises a receptacle cup, a fuel element and a wick. The fuel element is loosely placed in the receptacle cup and the wick is pulled through the fuel element. For this purpose, the fuel element has an axial throughbore for the wick. The wick is carried by a wick plate and is thereby fixed in its position relative to the fuel element.

The fuel element for a tea light and a candle comprise a fuel mass which has a solid state at normal ambient temperature and becomes completely liquid only under the action of the heat of the flame. As a rule, the fuel mass comprises paraffin or wax.

Fuel masses are, however, also known which contain renewable raw materials such as stearin, palmitin and/or other plant fats. Such renewable raw materials can be extruded only with difficulty because of their crystal structure. These raw materials are therefore not suitable for the manufacture of molded tea lights of the known state of the art.

The selection of raw materials and the recipe are essentially made in accordance with the practiced manufacturing method.

Various methods are known for the manufacture of fuel elements for a tea light or for a candle. Accordingly, liquid paraffin or stearin or a mixture of both is used which is poured in measured quantities into a mold where the fuel mass cools down and assumes its final solid form. A fuel element results with a uniform lattice structure which acts positively on the stability of the candle. This method requires a high complexity with respect to apparatus for introducing the wick and for holding the wick in the axial position. The significant disadvantage of this pouring method is, however, that the fuel material requires a long time to solidify after pouring. This causes the pouring method to be complex and expensive.

It is also known to first cool down liquid paraffin to a pasty state. In this state, the fuel mass is then placed in measured quantities into corresponding molds and, thereafter, is cooled down to solidification. Here too, problems result with the alignment and the fixation of the wick and the solidifying time after the placement is still too long.

A well known method for making candles is pulling. Here, a wick is pulled repeatedly through a paraffin bath and, in this way, a thin paraffin layer is built up concentrically about the wick with each passthrough. This operation is repeated until the wanted candle diameter is reached. Here, the coated wick must be reorientated again and again in order to run anew through the paraffin bath. In this way, a continuous coated wick is formed which is subsequently cut to the desired candle length. In this method too, no uniform lattice structure can develop and the stability of the candles is not high. The reorientation of the coated wick requires, on the one hand, a high complexity with respect to apparatus and, on the other hand, a paraffin recipe which results in an elastically deformable coated wick. This imposes considerable limitations on the selection of raw materials and acts negatively on cost.

It has become very common to use liquid paraffin as a starter material and to add color materials and scent materials as required and to then spray the liquid paraffin in a cold air flow so that the paraffin solidifies to powder or to granulate. This powder or this granulate is then utilized as an intermediate product for a later extrusion.

A corresponding extrusion is, for example, applied to the manufacture of tea lights wherein the granulate is metered and is put into a forming tool where the granulate is extruded under the action of force to the wanted fuel element of a tea light with a center wick bore. Thereafter, the fuel element and the wick are assembled.

The powder or granulate made in this way is, however, also used for the extrusion pressing of a candle as known, for example, from Swiss Patent 414,048. Here, the powder or granulate is supplied to a single-shaft extruder wherein it is compressed and formed to an extruded element. At the same time, a wick is introduced over the entire length of the extruder through the extruder shaft which is configured as a hollow shaft. The wick is then worked in during the compression of the fuel mass. A twisting effect is imparted to this wick by the rotation of the extruder shaft and this twisting action acts negatively on the burning performance of the candle. The fuel mass is formed to an extruded element by a mouthpiece and is sequentially cut to the required lengths of a candle.

The spraying of a liquid fuel mass and the solidification of the liquid fuel mass to a powder or granulate and the subsequent molding of the powder or granulate have, however, significant disadvantages.

Granulation and extrusion are two different methods which take place in different apparatus and are accordingly spatially separated and therefore require a high complexity with respect to apparatus. The spatially and time separated methods are also associated with logistical disadvantages. Furthermore, the condensate of the air moisture, which inexorably results during the formation of granulate, presents processing problems.

A significant disadvantage is also that, in principle, only paraffin can be used as a starter raw material and additive materials such as stearin, palmitin and/or other plant fats can be admixed only in small quantities because of their poor extrudability.

When molding granulate, the grain structure of the granulate is maintained and no homogeneous structure with a unified lattice structure results which acts negatively on the stability of the candle. A further disadvantage results when scent materials must be added to the fuel mass. This takes place by admixing these substances in the liquid phase. During the spraying of the mixture of the liquid paraffin and scent material, it cannot be prevented that the highly volatile components of the scent materials escape uncontrolled into the atmosphere and are therefore lost. Accordingly, it is not possible to provide a tea light or candle with a defined scent or fragrance and to ensure the same scent or fragrance for all manufactured tea lights or candles. Furthermore, the manufacturing costs increase because of the losses.

The granulation via a spraying leads to further qualitative disadvantages. Accordingly, the powder and granulates tend to become sticky and form clumps because, on the one hand, different solidification states occur because of the temperature sensitivity of the paraffin after spraying and some powder particles or granulates are still soft and sticky and because, on the other hand, the powder particles and the granulates are formed to have multifaceted surface structures with many corners and edges during solidification which, in the rigid state, cause interlocking. This reduces the flow capability of the powder or of the granulate and hinders the conveyance and metering.

### SUMMARY OF THE INVENTION

In view of the above, it is an object of the invention to provide a candle, fuel element for a tea light or a granulate for the candle or for the fuel element having an increased quality whose fuel mass can be molded.

It is also an object of the invention to provide a method and an apparatus for making the candle, fuel element for a tea light or granulate wherein the complexity with respect to apparatus is reduced.

The candle, fuel element for a tea light or a granulate for a candle or for the fuel element of the invention includes: paraffin and components of renewable raw materials; and, the candle, the fuel element or the granulate being extruded and the portions of the renewable raw materials being more than 30%.

The method of the invention is for making a candle, a fuel element for a tea light or a granulate for the fuel element or the candle. The method includes the steps of: providing a liquid and heated fuel mass; selectively adding additives and additional substances to the fuel mass while applying a thermal treatment thereto and while homogeneously mixing the fuel mass and the additives and additional substances; compressing the homogeneous mixture to a pasty mass and pressing the homogeneously mixed mass to form a compacted element; carrying out the steps of mixing, compressing and pressing in a closed chamber and in a continuous process; continuously cooling the liquid and heated fuel mass during the continuous process; and, separating the compacted element into predetermined lengths.

The method and the apparatus according to the invention eliminate the above-mentioned disadvantages of the state of the art and make possible the production of candles, tea lights and granulate having more than 30% fuel material component from renewable raw materials in the form of stearin, palmitin or other plant or animal fats. Furthermore, an extruded element results having a uniform lattice structure and therefore candles having a high stability are produced. The granulate, which is made in accordance with the method of the invention, exhibits a smooth surface and is especially able to flow.

### BRIEF DESCRIPTION OF THE DRAWINGS

The invention will now be described with reference to the drawings wherein:

FIG. 1 is a schematic of the apparatus according to an embodiment of the invention;

FIG. 2 is a schematic of an apparatus according to the invention equipped with a cutting device for the granulate;

FIG. 3 is a schematic of an apparatus according to an embodiment of the invention having a molding tool for the fuel element of a tea light;

FIG. 4 is a schematic of an apparatus according to an embodiment of the invention having a cutting device and a gang saw for the fuel element of a tea light; and,

FIG. 5 is a schematic of an apparatus of the invention with a wick feed for a candle.

### DESCRIPTION OF THE PREFERRED EMBODIMENTS OF THE INVENTION

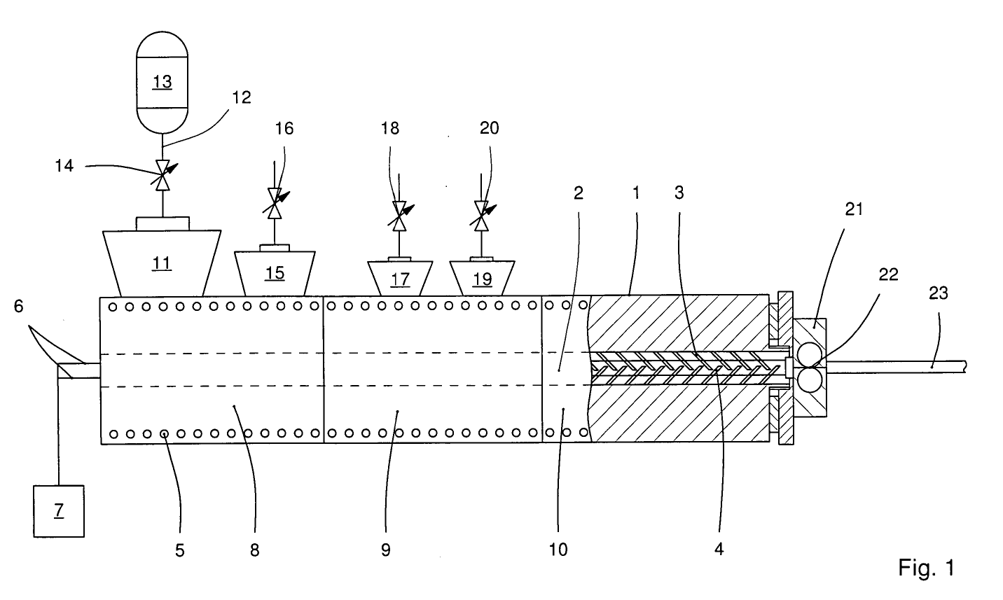

According to FIG. 1, the apparatus for making a candle, a fuel element and granulate essentially includes a housing 1 and a driven extrusion unit 2 having a first extruder spindle 3 and a second extruder spindle 4. The two extruder spindles (3, 4) are configured to be opposite each other and to run in opposite directions to each other. The extrusion unit 2 is configured in modular form over its length and has sets of threads with form and pitch different from module to module. The form and pitch are orientated to the different functions of the extrusion unit 2 in the individual units of the apparatus.

The apparatus is configured as a cooling path over its entire length. For this purpose, the housing 1 is equipped in its wall with peripherally-extending cooling channels 5 and the two extruder spindles (3, 4) are equipped with corresponding axial cooling channels 6. All cooling channels (5, 6) are connected to an external control cooling unit 7. Cooling water is preferably used as a coolant.

The apparatus is made up of several segments over its length. Viewed in the conveying direction, first a mixing unit 8 is arranged and then a homogenization unit 9 and then a compressing and molding unit 10.

The mixing unit 8 is equipped with a fill funnel 11 for a liquid fuel mass and is connected via a feed line 12 to a liquid tank 13. In the feed line 12, an adjustable fuel mass metering device 14 is mounted whose adjusting unit is functionally connected to the drive of the extrusion unit 2. The mixing unit 8 additionally has a fill unit 15 for additives. The fill unit 15 likewise has an additive metering unit 16 which is adjustable and connected to the drive of the extrusion unit 2.

The homogenization unit 9 has, in contrast, a fill unit 17 for a coloring material and has a coloring metering unit 18 and a fill unit 19 for a scent material with a scent material metering unit 20. The homogenization unit 9 in connection with the housing 1 is so configured that a closed system results and an escape of the highly volatile scent material components is prevented. The two metering devices (18, 20) are, in turn, adjustably configured and are connected to the drive of the extrusion unit 2 via control units.

An exchangeable form matrix 21 having a selected form nozzle 22 is disposed behind the compression and molding unit 10 in the feed direction. This form nozzle 22 is so configured that it forms a continuous extrusion 23 in combination with the pressure in the compressor and molding unit 10. This extrusion 23 is then the starting point for a further processing.

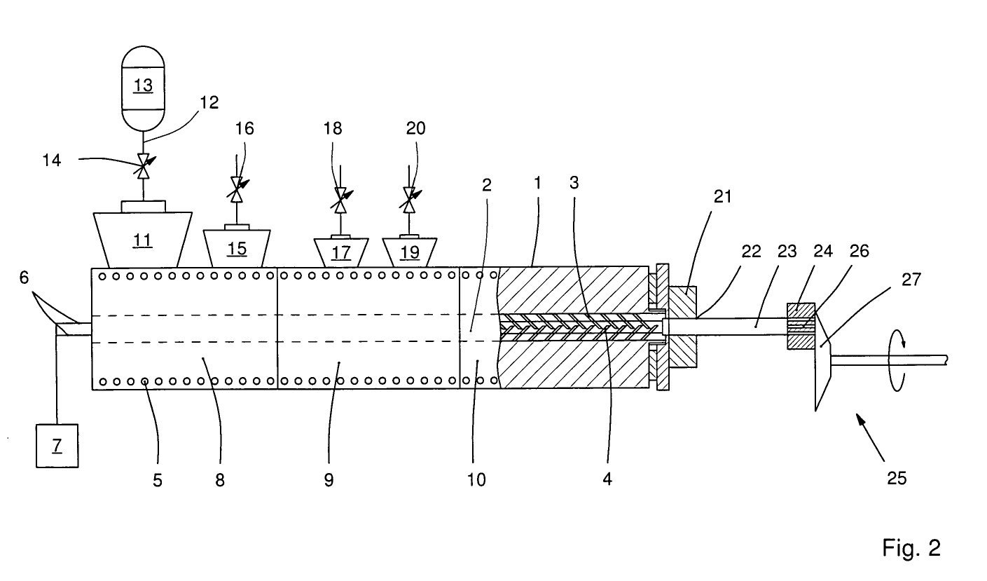

FIG. 2 shows a like apparatus which is equipped with a further form matrix 24 and a cutting device 25 for making granulate. This form matrix 24 has a hole mask nozzle 26 and the cutting device 25 has one or several cutting knives 27 rotating in a plane. The two cutting knives define a cutting pair.

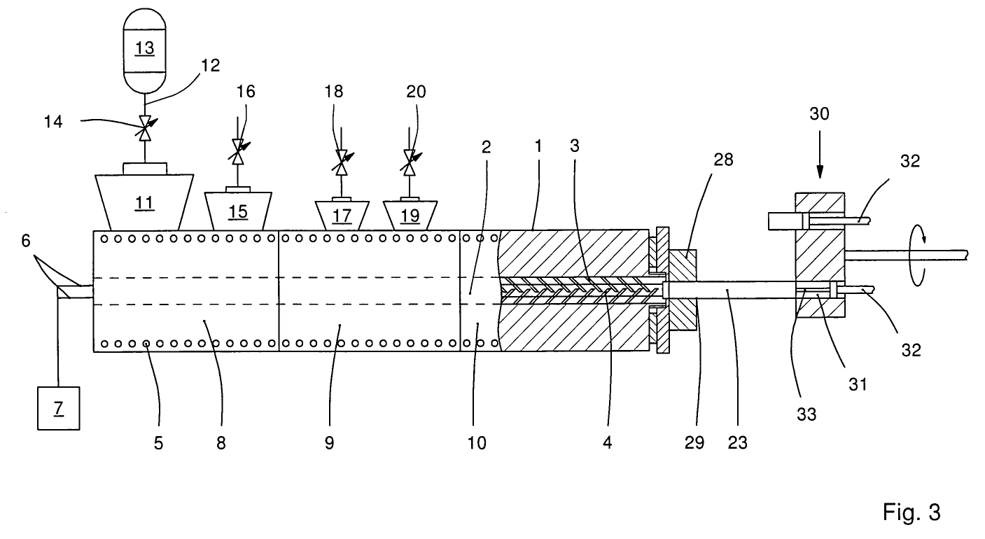

As shown in FIG. 3, the apparatus includes a form matrix 28 having an aperture nozzle 29 for making the extrusion 23 which is a starting point for the making of fuel elements for tea lights. A form tool 30 is arranged downstream of the form matrix 28. The form tool 30 is configured as a revolver head having several form chambers 31 arranged uniformly on a same part circle. The common part circle of all form chambers 31 is on the axis of the extrusion and each form chamber 31 has a discharge unit 32 which is preferably driven pneumatically and which is equipped with a center form pin 33 for the wick bore on the injection end. A power introducing unit (not shown) is disposed in a peripheral region of the common part circle of all form chambers 31. The force introduction unit applies an actuating force F to the particular discharge unit 32 disposed just then in position. The actuating force F is preferably directed opposite to the conveying direction of the fuel mass.

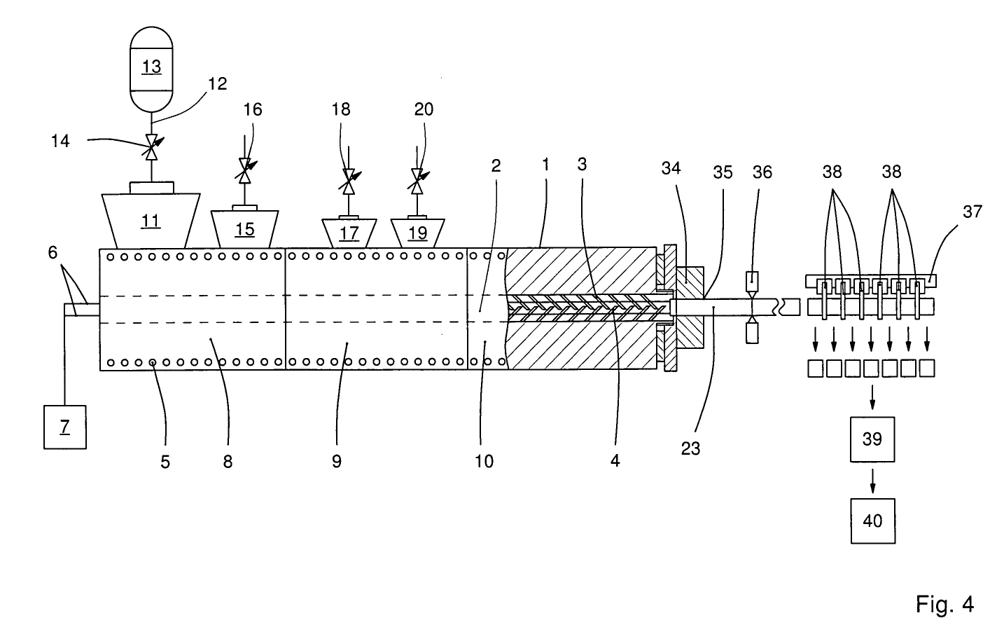

According to FIG. 4, the extrusion apparatus is configured for making fuel elements for tea lights and is therefore equipped with a form matrix 34 which has an annular nozzle 35 for making an extrusion 23 having a center bore. A cutting device 36 is mounted downstream of the form matrix 34 for cutting the tubular-shaped extrusion 23 to a selected length. A gang saw 37 is provided downstream of the cutting device 36 and has several uniformly spaced cutting or saw blades 38. The spacing of all cutting and saw blades 38 corresponds to the length of the fuel element for the tea light. A separation unit 39 for the separated fuel elements and an assembly device 40 for completing the tea light are parts of the extrusion apparatus and follow downstream.

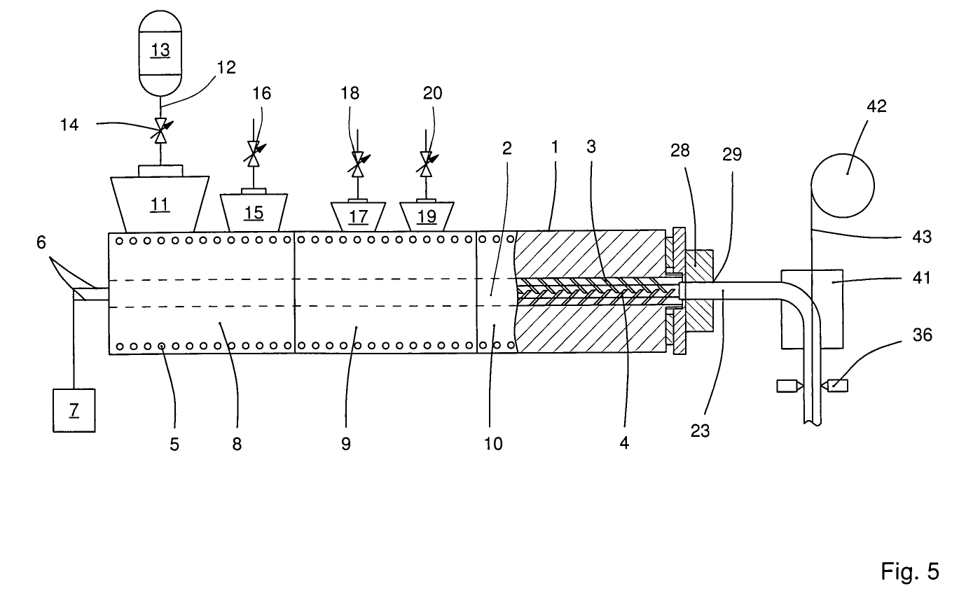

The apparatus of FIG. 5 is designed for making a candle and is therefore, in turn, equipped with a form matrix 28 to which the aperture nozzle 29 belongs. A form body 41 is disposed downstream thereof for accommodating and redirecting the extrusion 23 in a direction angled by 90°. A wick feed unit 42 belongs to this form body 41. The wick feed unit 42 introduces a continuous wick 43 into the extrusion 23 which still has pasty characteristics. The continuous wick 43 is arranged axially to the angled extrusion 23.

The function of the extrusion apparatus will now be explained.

In accordance with a predetermined recipe, heated and liquid paraffin and selectively also additive substances such as stearin, palmitin and/or other plant or animal fats are continuously introduced into the fill funnel 11 for the paraffin and the fill unit 15 for the additives. The additive materials are likewise warmed and liquid. In this way, all the starter substances arrive at the mixture unit 8 where they come into contact with the walls of the housing 1 and the extrusion unit 2. The paraffin and the additives are mixed with each other by the rotational movement of the extrusion unit 2 and are moved in the direction toward the homogenization unit 9 via the special configuration of the extrusion unit 2. At the same time, the temperature of the introduced fuel mass is continuously reduced because heat is continually withdrawn from the fuel mass because of the contact with the cooled extrusion unit 2 and the cooled walls of the housing 1. This cooling process is further accelerated in that not only the different starter substances but simultaneously also the components of the fuel mass, which are still warm, and the components of the fuel mass, which are already cooled, are continuously mixed with each other. The cooling channels 5 in the housing 1 and the cooling channels 6 in the extrusion unit 2 extend over the entire length of the extrusion apparatus. For this reason, the continuous cooling acts over the entire time span of the mixture and compression process. The fuel mass has a pasty consistency at the end of the cooling path which exhibits a uniform lattice structure during subsequent solidification.

In the homogenization unit 9, scent materials and/or color materials are added as required and in measured quantities. These materials are then mixed with the fuel mass to a homogeneous mass and are moved farther. For this purpose, the extrusion unit 2 is configured in a special way in this region. Since the extrusion apparatus defines a closed unit, the scent materials cannot volatilize.

In the compressor and molding unit 10, the fuel mass prepared in this manner is pressed by the conveying force of the special extrusion unit 2 and against the resistance of the particular form nozzle (22, 24) or the aperture nozzle 29 or the annular nozzle 35 to an extrusion 23. The extrusion 23 is then further processed for the manufacture of granulate in accordance with FIG. 2 and for the manufacture of fuel elements for tea lights according to FIGS. 3 and 4 and for the manufacture of candles in accordance with FIG. 5.

The extrusion 23 is pressed through a likewise cooled aperture mask nozzle 26 (FIG. 2) for making granulate whereby several parallel extrusion filaments of smaller diameter result. The extrusion filaments, which exit from the many bores of the aperture mask nozzle 26, are immediately separated to short ends by the rotating and high speed cutting knife 27. In this way, granulate results in a unitary and cylindrical form with a small diameter and with a short length. These granulates have a smooth peripheral surface and therefore have a good pourability because of the processing.

The extrusion 23 is pressed into a form chamber 31 of a molding tool 30 (FIG. 3) to make the fuel elements for the tea lights. After the complete filling of the form chamber 31, the form tool 30 rotates the form chamber 31 from the moving direction of the extrusion apparatus and cuts the filled and pressed fuel mass from the extrusion 23. In a position lying outside of the direction of movement, the fuel mass, which is pressed to a fuel element, is discharged out of the mold chamber 31. The pressing, cutting and discharge of the completed fuel element takes place in synchronism for manufacturing reasons and in a form tool 30 which is likewise cooled. The mold tool 30 is configured as a revolving drum. To manufacture fuel elements for the tea lights, the extrusion 23 is simultaneously provided with a throughbore by utilizing a cooled annular nozzle 35 and then cut off at a predetermined length with the cutting device 36 (FIG. 4). The separated extrusion part is then supplied to a gang saw 37 where it is subdivided to the length required for the tea lights. These fuel elements are thereafter separated from each other and are supplied to an assembly unit 40 where they are then completed with a wick 43 and the receptacle container to provide a tea light.

As shown in FIG. 5, to manufacture a candle, an aperture nozzle 29 is again set into the apparatus in order to obtain a full volume extrusion 23. This extrusion 23 is still plastic and is deflected through an angle in a mold body 41 with the conveying movement and is joined with a wick 43 which is aligned axially to the angled extrusion 23. The wick is supplied by a wick feed unit 42. The extrusion 23 is cooled down to a solid state so that a uniform lattice structure can form in the fuel mass. A separating device 36 separates the extrusion 23 to the length predetermined for a candle.

It is understood that the foregoing description is that of the preferred embodiments of the invention and that various changes and modifications may be made thereto without departing from the spirit and scope of the invention as defined in the appended claims.

What is claimed is:

1. A candle, fuel element for a tea light or a granulate for a candle or for the fuel element, comprising:
paraffin and components of renewable raw materials; and,
said candle, said fuel element or said granulate being extruded and the portions of said renewable raw materials being more than 30%.

2. The candle, the fuel element or the granulate of claim 1, wherein said renewable raw materials comprise stearin, palmitin or other plant or animal fats.

3. A method of making a candle, a fuel element for a tea light or a granulate for said fuel element or said candle, the method comprising the steps of:
providing a liquid and heated fuel mass;
selectively adding additives and additional substances to said fuel mass while applying a thermal treatment thereto and while homogeneously mixing said fuel mass and said additives and additional substances;
compressing the homogeneous mixture to a pasty mass and pressing the homogeneously mixed mass to form a compacted element;
carrying out said steps of mixing, compressing and pressing in a closed chamber and in a continuous process;
continuously cooling said liquid and heated fuel mass during said continuous process; and,
separating said compacted element into predetermined lengths.

4. The method of claim 3, wherein said continuous process is an extrusion process and said compacted element is an extrusion.

5. The method of claim 4, comprising the further steps of:
subdividing said extrusion into a plurality of mutually parallel extrusion filaments of small diameter utilizing an aperture mask nozzle; and,
cutting all of said extrusion filaments into small lengths utilizing a cutting device.

6. The method of claim 4, comprising the further steps of:
separating said extrusion into extrusion lengths; and,
compacting said extrusion lengths in a forming tool to form respective fuel elements for tea lights.

7. The method of claim 4, comprising the further steps of:
compacting said extrusion into a forming tool to form a formed fuel element;
separating said extrusion by imparting a relative movement to said forming tool; and,
discharging said fuel element from said forming tool.

8. The method of claim 4, comprising the further steps of:
providing said extrusion with a throughbore for a wick with the aid of an annular nozzle;
separating said extrusion into like fuel elements; and,
assembling said fuel elements with said wick and a receptacle to form a tea light.

9. The method of claim 8, comprising the further step of separating several like fuel elements from said extrusion so as to form individual pieces.

10. The method of claim 4, comprising the further steps of:
deflecting said extrusion through an angle in a mold body;
feeding a wick axially to the angled extrusion and joining said wick with said extrusion; and,
separating a segment of said extrusion with said wick to form a candle having a predetermined length.

11. An apparatus for making a candle, a fuel element for a tea light or a granulate for said fuel element or said candle, the apparatus comprising:
a plurality of units for processing a fuel mass from a liquid state to a pasty state;
a first one of said units being a mixing unit to which said fuel mass and additives and additional substances are supplied and mixed;
a second one of said units being a compressing and compacting unit connected to said first unit;
said first and second units being combined to an assembly; and,
cooling means for thermally treating said fuel mass from said first unit to said second unit.

12. The apparatus of claim 11, further comprising an extrusion unit extending through said assembly and said assembly having a housing wall; and, said cooling means including cooling channels in said housing wall and cooling channels in said extrusion unit.

13. The apparatus of claim 11, further comprising an exchangeable form matrix disposed downstream of said second unit for providing different extrusion forms; and, a cutting device disposed downstream of said form matrix for said candles, said fuel elements and said granulates.

14. The apparatus of claim 11, further comprising an exchangeable form matrix having an aperture nozzle for a full volume extrusion for making a fuel element for a tea light; a form tool for compacting said fuel element; said exchangeable form matrix and said form tool being disposed downstream of said second unit; said form tool being equipped with at least one form chamber and a discharge device corresponding thereto; and, said form tool being so radially rotatably configured that the finished fuel element in said form chamber is separated from the extrusion and displaced into a discharge position.
